(19) United States
(12) Patent Application Publication
(10) Pub. No.: US 2020/0213009 A1
(43) Pub. Date: Jul. 2, 2020

(54) OPTICAL COMMUNICATION APPARATUS, SERVER APPARATUS, OPTICAL TRANSPORT SYSTEM, AND OPTICAL COMMUNICATION METHOD

(71) Applicant: FUJITSU LIMITED, Kawasaki-shi (JP)

(72) Inventors: Naoya OKADA, Yokohama (JP); Taizo MAEDA, Kawasaki (JP); Kosuke Komaki, Kawasaki (JP)

(73) Assignee: FUJITSU LIMITED, Kawasaki-shi (JP)

(21) Appl. No.: 16/708,715

(22) Filed: Dec. 10, 2019

(30) Foreign Application Priority Data
Dec. 28, 2018 (JP) 2018-248337

(51) Int. Cl. H04B 10/516; H04B 10/69; H04B 10/61

(52) U.S. Cl. CPC H04B 10/5161; H04B 10/612; H04B 10/6932

(57) ABSTRACT

An optical communication apparatus includes an interface circuit that acquires bit rate information of an optical network, and a processor that selects a modulation scheme in accordance with the bit rate information and operates in the modulation scheme, wherein the processor is configured to select a first modulation scheme when the bit rate is equal to or greater than a first value, and select a second modulation scheme when the bit rate is smaller than the first value, the second modulation scheme having a data transfer performance higher than the first modulation scheme.

### CROSS-REFERENCE TO RELATED APPLICATIONS

This application is based upon and claims priority to earlier filed Japanese Patent Application No. 2018-248337 filed Dec. 28, 2018, which is incorporated herein by reference in its entirety.

### FIELD

The present invention relates to an optical communication apparatus, a server apparatus, an optical transport system, and an optical communication method.

### BACKGROUND

In response to growing demand for expansion of data transmission volume, digital coherent techniques have been widely spreading to achieve high-speed high-capacity optical communications. With a digital coherent technique, a received light signal is detected using a local oscillation light beam, and digital processing is applied after optical-to-electrical conversion of the detected light signal to compensate for waveform distortion generated on the optical transmission path. Since individual chromatic dispersion compensators as well as optical amplifiers for compensating for the insertion loss, which have been required in a conventional technique, are omitted, the system can be downsized and stabilized, while achieving cost reduction.

For a next-generation optical transponder equipped with a digital signal processor, adaptive modulation schemes are discussed. In adaptive modulation, a bandwidth or a bit rate of a network is selective and the system will operate with a modulation scheme suitable to the selected bit rate. However, in reality, it is difficult to use appropriately adaptive modulation because the spectrum width expands upon increase of a baud rate responsive to an increased bit rate. Besides, baud rate is limited due to limit in speed of a digital-to-analog converter (DAC), and it cannot be increased beyond the limit of the DAC speed.

An optical communication technique capable of maintaining a transmission quality and suppressing an increase in power consumption is desired when performing adaptive modulation in accordance with a bit rate.

A new modulation scheme, 4-dimensional m-ary amplitude, n-ary phase shift keying (4D-mAnPSK) is proposed. See, for example, Japanese Laid-open Patent Publication No. 2017-513347 (JP 2017-513347 A). It is proposed to use, for example, 4D-2A8PSK and 4D-2A16QAM in place of conventional DP-8QAM and DP-16QAM.

### SUMMARY

In one aspect of the invention, an optical communication apparatus includes
an interface circuit that acquires bit rate information of an optical network, and a processor that selects a modulation scheme in accordance with the bit rate information and operates in the modulation scheme,
wherein the processor is configured to select a first modulation scheme when the bit rate is equal to or greater than a first value, and select a second modulation scheme when the bit rate is smaller than the first value, the second modulation scheme having a data transfer performance higher than the first modulation scheme.

The object and advantages of the invention will be realized and attained by means of the elements and combinations particularly pointed out in the claims. It is to be understood that both the foregoing general description and the following detailed description are exemplary and explanatory and are not restrictive to the invention as claimed.

### BRIEF DESCRIPTION OF DRAWINGS

FIG. 1 is a diagram for explaining a technical problem arising in use of 4D-mAnPSK;

FIG. 2A is a diagram for explaining a technical problem arising in use of 4D-mAnPSK;

FIG. 2B is a diagram for explaining a technical problem arising in use of 4D-mAnPSK;

FIG. 3A is a diagram for explaining a technical problem arising in use of 4D-mAnPSK;

FIG. 3B is a diagram for explaining a technical problem arising in use of 4D-mAnPSK;

FIG. 4 is a diagram for explaining a technical problem arising in use of 4D-mAnPSK;

FIG. 5 is a schematic diagram of a hardware structure of an optical transmitter which is an example of an optical communication apparatus of an embodiment;

FIG. 6 illustrates an example of associated information representing a correspondence relation between bit rate and modulation scheme;

FIG. 7 is a functional block diagram of the optical transmitter of FIG. 5;

FIG. 8 is a schematic diagram of a hardware structure of an optical receiver which is an example of an optical communication apparatus of an embodiment;

FIG. 9 is a schematic diagram of a hardware structure of an optical transceiver which is an example of an optical communication apparatus of an embodiment;

FIG. 10 is a flowchart of selecting a modulation scheme in accordance with a bit rate;

FIG. 11A is a constellation diagram of 4D-2A8PSK for X-polarized wave;

FIG. 11B is a constellation diagram of 4D-2A8PSK for Y-polarized wave;

FIG. 12 is a flowchart of a modified operation of selecting a modulation scheme in accordance with a bit rate;

FIG. 13 is a flowchart of another modified operation of selecting a modulation scheme in accordance with a bit rate;

FIG. 14 is a schematic diagram of an optical transport system according to an embodiment;

FIG. 15 is a schematic diagram of a transponder which is an example of an optical communication apparatus of an embodiment; and

FIG. 16 is a schematic diagram illustrating a server apparatus and an optical transceiver used in an optical transport system of an embodiment.

### DESCRIPTION OF EMBODIMENTS

In an embodiment, when a bit rate equal to or greater than a predetermined value is selected, an optical signal is transmitted in a first modulation scheme (for example, a quadrature amplitude modulation (QAM)). When a bit rate which is less than the predetermined value is selected, an optical signal is transmitted in a second modulation scheme (for example, 4D-mAnPSK) that has a higher performance of fiber optic data transfer, thereby achieving adaptive modulation in accordance with the bit rate.

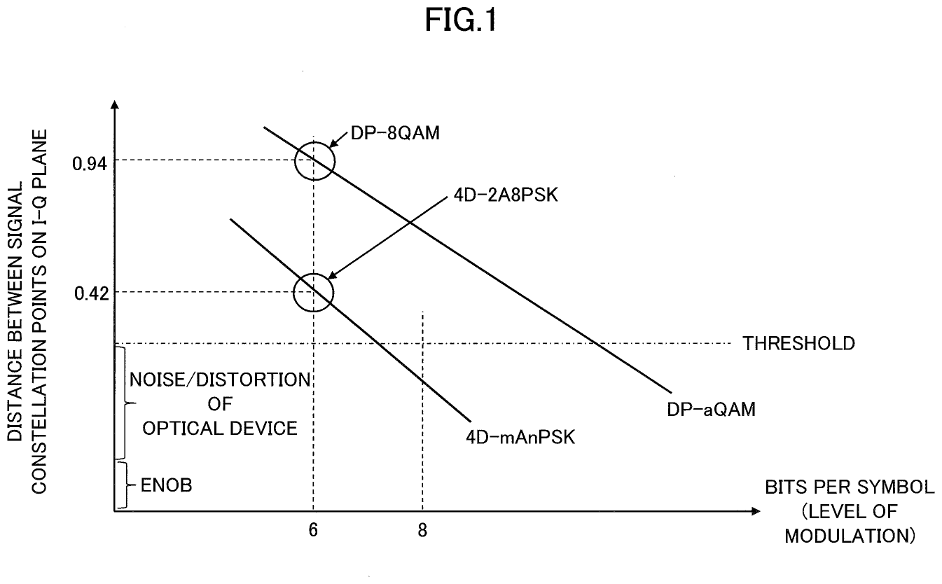

Prior to describing particulars of the structures and methods of the embodiments, explanation is made to technical problems in the conventional 4D-mAnPSK found by the inventors, with reference to FIG. 1 to FIG. 4.

4D-mAnPSK provides “m” amplitude levels and “n” optical phases using four light components, XI (X-polarized wave, in-phase component), XQ (X-polarized wave, quadrature component), YI (Y-polarized wave, in-phase component), and YQ (Y-polarized wave, quadrature component). In order to achieve a higher bit rate over 400 Gbps, the “m” value or the “n” value of 4D-mAnPSK needs to be increased. Because the 4D-mAnPSK scheme has a greater number of signal points on the constellation plane (i.e., I-Q plane) compared to a QAM scheme, the distance between constellation points becomes shorter as the number of bits per symbol increases, and the transmitter will exceed the margin not meeting with the required conditions faster than QAM schemes. Besides, the amount of computation for determining a constellation point is greater than QAM schemes, and the limit of power consumption is easily breached when the level of multilevel in modulation (i.e., the number of bits per symbol) increases.

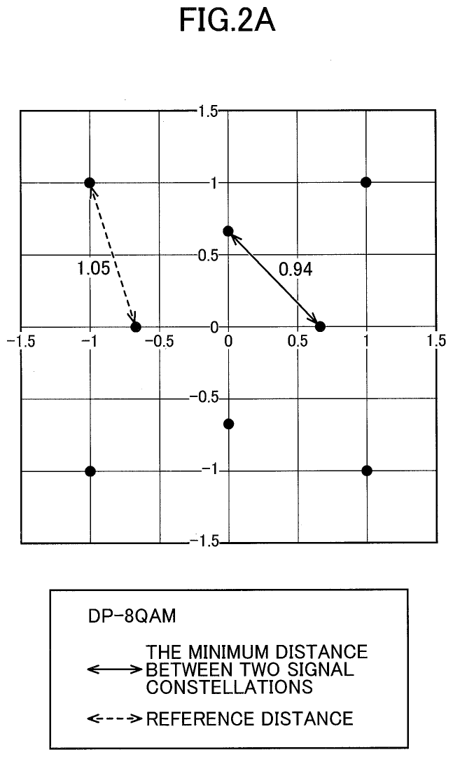

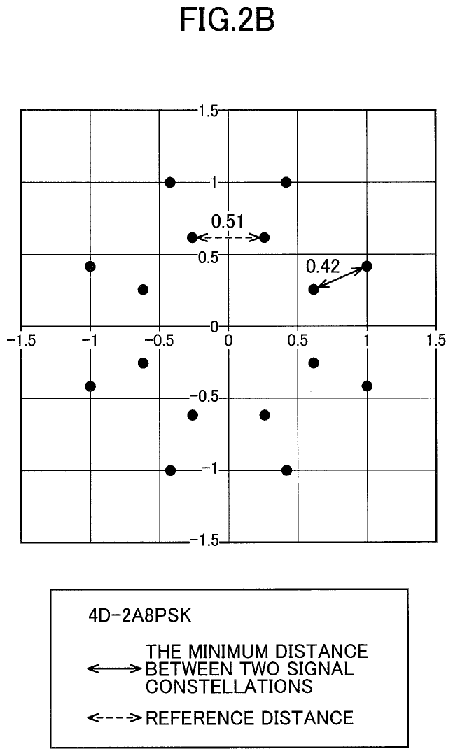

FIG. 1, FIG. 2A, and FIG. 2B are diagrams for explaining the first problem arising in use of 4D-mAnPSK. The horizontal axis in FIG. 1 represents level of modulation (bits per symbol), and the vertical axis represents distance between signal constellation points on an I-Q plane. The distance between signal constellation points on the I-Q plane is designed so as to be greater than or at least equal to the minimum threshold required, taking into account the effective number of bits (ENOB), variations due to noise or distortion generated by the optical device, and other factors.

Comparing between DP-8QAM and 4D-2A8PSK, there are a greater number of constellation points on the I-Q plane with 40-2A8PSK. When the level of modulation or the number of bits per symbol is increased, the distance between constellation points becomes less than the threshold earlier in 4D-2A8PSK.

FIG. 2A and FIG. 2B are constellation diagrams of DP-8QAM and 2A8PSK, respectively. The bidirectional solid arrows represent the minimum distances between signal constellation points, and the bidirectional dashed arrows represent reference distances.

In FIG. 2A, DP-8QAM carries out 3-bits/symbol modulation per polarization. In using two polarized waves whose directions of polarization are orthogonal to each other, 6-bits/symbol modulation is achieved. The minimum distance between signal constellation points is 0.94, and the reference distance is 1.05.

In the 4D-2A8PSK of FIG. 2B, signal constellation points are distributed such that when the amplitude of the X-polarized wave is r1 (for example, the inner circle) in a certain time slot, the amplitude of the Y-polarized wave becomes r2 (for example, the outer circle), and that when the amplitude of the X-polarized wave is r2 (for example, the outer circle), the amplitude of the Y-polarized wave becomes r1 (for example, the inner circle). Under this limitation in amplitude, the power for each symbol is maintained constant, while 3 bits in the phase direction of X-polarized wave, 3 bits in the phase direction of Y-polarized wave, and the total of 6-bits per symbol modulation is performed. With 4D-2A8PSK, the minimum distance between signal constellation points is 0.42 and the reference distance is 0.51.

Returning to FIG. 1, for example, in 6-bits/symbol modulation, the distance between signal constellation points becomes shorter than the minimum threshold required for a transmitter in both DP-8QAM and 4D-2A8PSK. Because 4D-2A8PSK is designed such that the power per symbol is maintained constant, the influence of cross-phase modulation between adjacent channels is small, and fiber optic data transfer performance is better than DP-8QAM at the same amount of data.

However, 4D-2A8PSK has less margin in the distance between signal constellation points, and in reality, it cannot accommodate increase in the level of modulation. In contrast, DP-aQAM can increase the level of modulation compared to 4D-2ABPSK.

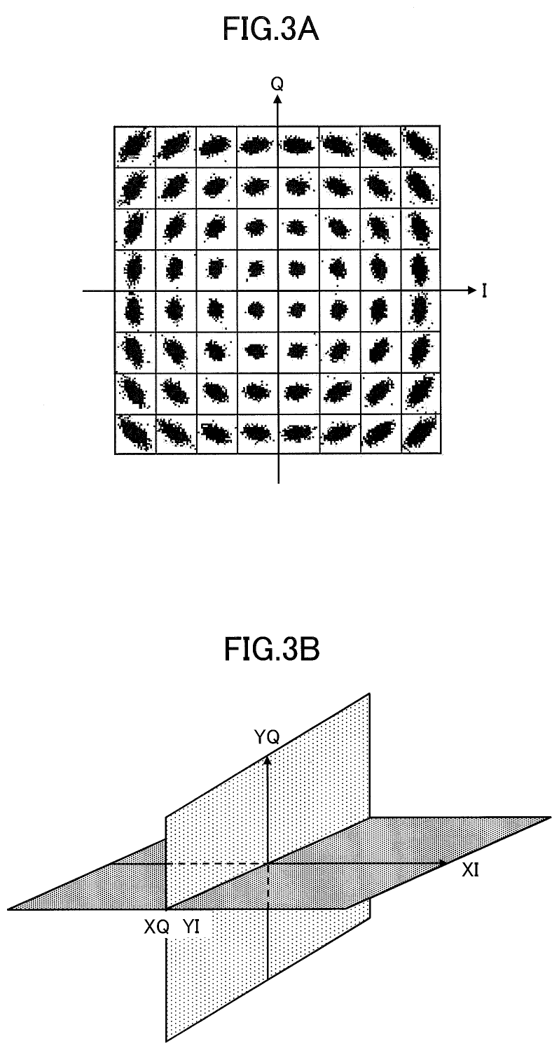

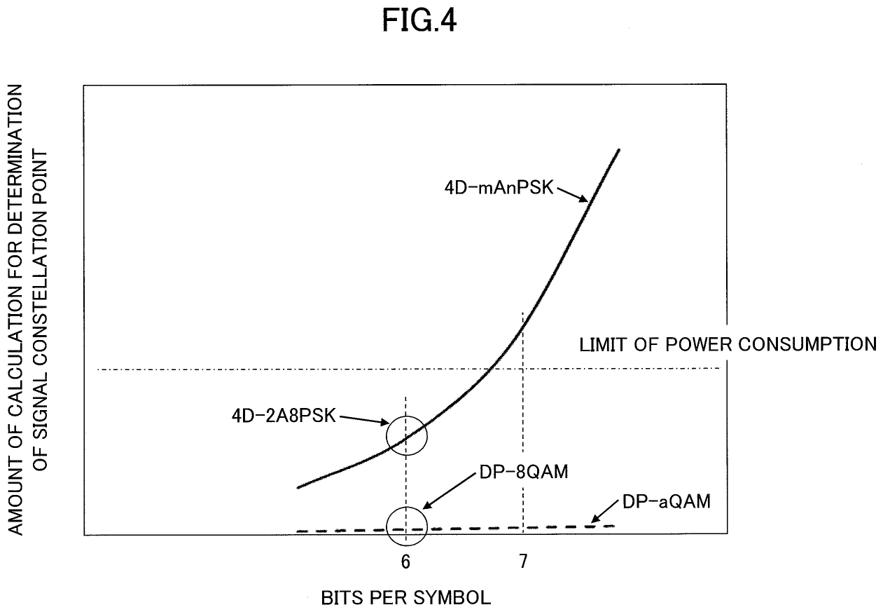

FIG. 3A, FIG. 3B, and FIG. 4 are diagrams for explaining the second problem arising in use of 4D-mAnPSK. In a DP-aQAM optical receiver, the received signal is plotted on the I-Q plane after being split into X-polarized wave and Y-polarized wave, as illustrated in FIG. 3A. The I-Q plane is divided into multiple areas corresponding to constellation points, and it is determined to which constellation point the received signal is the closest. For example, in 64 QAM, the received signal is plotted on the I-Q plane as illustrated in FIG. 3A and the area to which the received signal belongs is determined with less amount of calculation.

In FIG. 3B, with a 4D-mAnPSK optical receiver, in order to enhance the optical signal to noise ratio (OSNR) tolerance, the received signal is plotted into a constellation space expressed by I-Q planes of X-polarization and Y-polarization after being split into X-polarized wave and Y-polarized wave. Then it is determined to which constellation points in the constellation space the received signal corresponds. It is difficult in a constellation space with four axes of XI, XQ, YI and YQ to divide the space into sub-spaces corresponding to constellation points and determine which coordinates correspond to which constellation point.

For this reason, the distances from the measured received signal to all the constellation points are calculated, and the constellation point with the minimum distance is selected as the received data. In k-bits/symbol modulation, 2 k comparisons are required. Using 6-bits/symbol 4D-2A8PSK, 2⁶, namely 64 comparisons are performed to determine the constellation point with the minimum distance. The amount of computation is heavy compared to that in DP-aQAM modulation.

As illustrated in FIG. 4, the amount of calculation for determining a signal constellation point increases exponentially with 4D-mAnPSK, and the power consumption will easily exceed the upper limit. Upon exceeding the power consumption limit, the digital signal processor (DSP) causes thermorunaway, incapable of releasing or dissipating heat. In contrast, in DP-aQAM, the amount of calculation for determination of a constellation point does not vary so much even when the level of modulation of the number of bits per symbol increases.

To meet with such customer demands and solve the technical problems described above with reference to FIG. 1 to FIG. 4, the embodiment provides adaptive modulation in accordance with a selected bit rate, by using a first modulation scheme such as aQAM when the bit rate is equal to or greater than a predetermined value, and using a second modulation scheme such as 4D-mAnPSK when the bit rate is less than the predetermined value.

### <1. Configuration Example of Optical Transmitter>

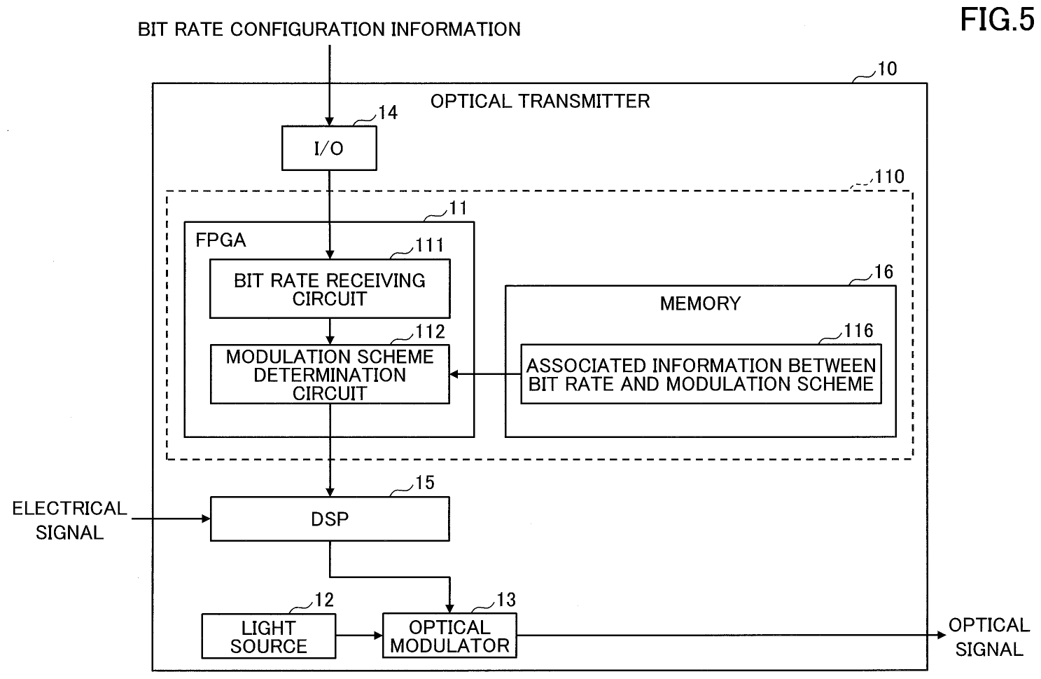

FIG. 5 is a schematic diagram illustrating a hardware structure of the optical transmitter 10 according to the embodiment. The optical transmitter 10 is an example of an optical communication apparatus, and it has a field programmable gate array (FPGA) 11, a light source 12, an optical modulator 13, an input/output interface (denoted as “I/O” in the figure) 14, a DSP 15, and a memory 16.

The FPGA 11 has a bit rate receiving circuit 111 and a modulation scheme determination circuit 112. The bit rate receiving circuit 111 receives bit rate configuration information via the input/output interface 14. The modulation scheme determination circuit 112 refers to associated information 116 saved in the memory 16 and determines a modulation scheme in accordance with the bit rate. The determined modulation scheme is input to the DSP 15. The FPGA 11 and the memory 16 may form a modulation scheme selector part 110, which will be described below.

Upon input of an electrical data signal for transmission, the DSP 15 performs error correction coding, maps the data onto the constellation according to the specified modulation scheme, and produces a signal representing the logic value of the data signal. The signal is subjected to digital-to-analog conversion and applied to the signal electrode of the optical modulator 13.

The light beam emitted from the light source 12 and incident on the optical modulator 13 from the light source 12 is modulated by an analog drive signal. The modulated light signal is output to the optical network.

The configuration of FIG. 5 is just an example, and the invention is not limited to this example. The associated information 116 may be stored in a memory block in the FPGA 11 or in an internal memory of the DSP 15. The FPGA 11 is an example of a logic device, and an alternative logic device such as a complex programmable logic device (CPLD) may be used. Instead of using a separate logic device such as the FPGA 11, the DSP 15 may be designed to receive the bit rate configuration information and determine the modulation scheme.

As long as the modulation scheme is selected in accordance with the bit rate from the associated information 116, any appropriate configuration may be employed.

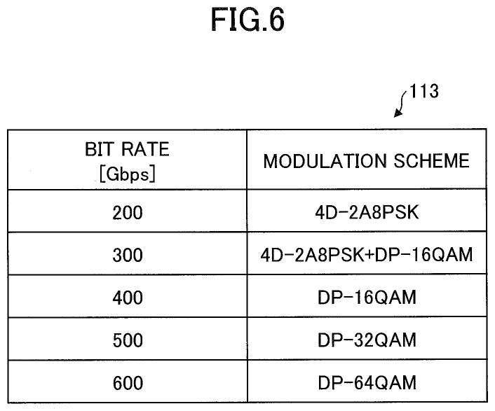

FIG. 6 illustrates a table 113, which is an example of associated information used in the embodiment. The table 113 describes a correspondence relation between bit rates to be used and the associated modulation schemes.

For instance, at a bit rate of 200 Gbps, 4D-2A8PSK is employed. In this case, signal transfer is carried out at an information amount of 6 bits per symbol and with a better data transfer performance (for example, with a higher tolerance to fiber optic nonlinearity).

When the bit rate is 400 Gbps or higher, DP-aQAM may be adopted. For example, at a bit rate of 400 Gbps, DP-16QAM is used. In this case, a data amount of 8 bits/symbol (4×2 bits per symbol) can be transmitted by one modulation. At the bit rate of 500 Gbps, DP-32QAM may be used, and at 600 Gbps, DP-64QAM may be used. Even when the bit rate increases to this extent, the distance between signal constellation points still has a margin, and the level in multilevel modulation can be raised until approaching the threshold limit. Besides, the amount of calculation for determining a constellation point is almost unchanged even though the level in multilevel modulation is increased. Accordingly, increase in power consumption can be suppressed.

At 300 Gbps, in order to carry out 7-bits/symbol modulation, hybrid modulation combining, for example, 4D-2A8PSK and DP-16QAM may be employed. Performing 6-bits/symbol 4D-2A8PSK and 8-bits/symbol DP-16QAM at a one-to-one ratio in a time sharing manner, 7-bits/symbol modulation is achieved on average.

In place of hybrid modulation, 7-bits/symbol 4D-2A8PSK scheme (abbreviated to “7b4D-2A8PSK”) may be used. In 7b4D-2A8PSK, bit B[0] to bit B[6] are modulation bits, bit B[7] is a parity bit with an inverted value of bit B[6], and these bits are distributed on the Poincare sphere. For more information about 7b4D-2A8PSK, please see Kojima et al, “S and 7 bit/symbol 4D Modulation Formats Based on 2A8 PSK”, Proceedings, ECOC 2016-42nd, Sep. 18, 2016.

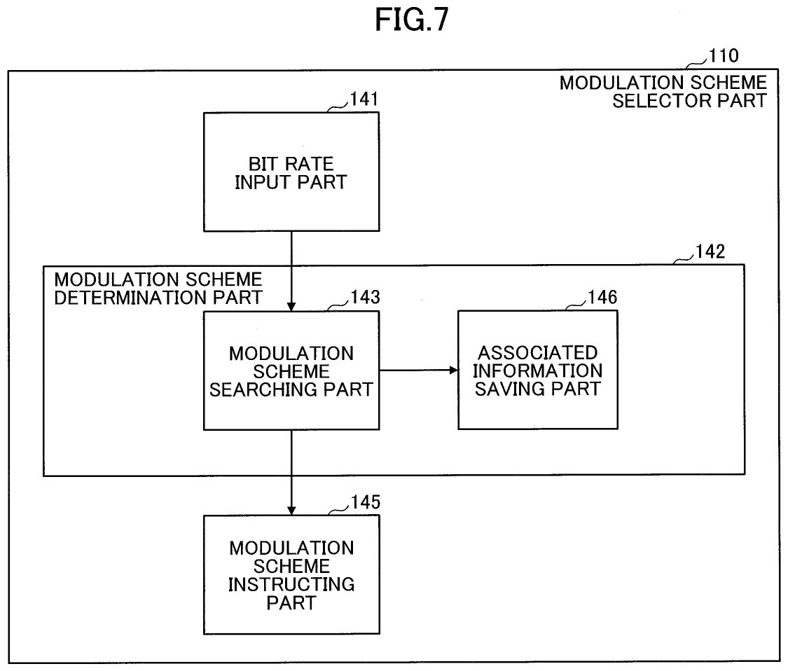

FIG. 7 is a functional block diagram of the modulation scheme selector part 110. As has been described above, the modulation scheme selector part 110 may be implemented by the FPGA 11 and the memory 16, or alternatively, it may be implemented only by the FPGA when the FPGA 11 has a built-in memory.

The modulation scheme selector part 110 includes a bit rate input part 141, a modulation scheme determination part 142, and a modulation scheme instructing part 145. The modulation scheme determination part 142 includes a modulation scheme searching part 143 and an associated information saving part 146. The information saved in the associated information saving part 146 may be table information as illustrated in FIG. 6 or a function that describes the relationship between the bit rate and the modulation scheme.

Based upon the bit rate received at the bit rate input part 141, the modulation scheme searching part 143 searches in the associated information saving part 146 to specify the modulation scheme corresponding to the bit rate. The modulation scheme instructing part 145 outputs the specified modulation scheme to the DSP 15.

When a function is saved in the associated information saving part 146, the function may describe the relation to select DP-aQAM when the bit rate is equal to or greater than the first threshold value, and select 4D-mAnPSK when the bit rate is less than the second threshold value that is small than the first threshold value. The function may further describe so as to select a hybrid scheme of DP-aQAM and 4D-mAnPSK when the bit rate is between the first threshold value and the second threshold value.

In the optical transmitter 10, an appropriate modulation scheme is selected according to the bit rate, and the data transfer quality is maintained satisfactorily, while suppressing the power consumption from increasing.

### <2. Configuration Example of Optical Receiver>

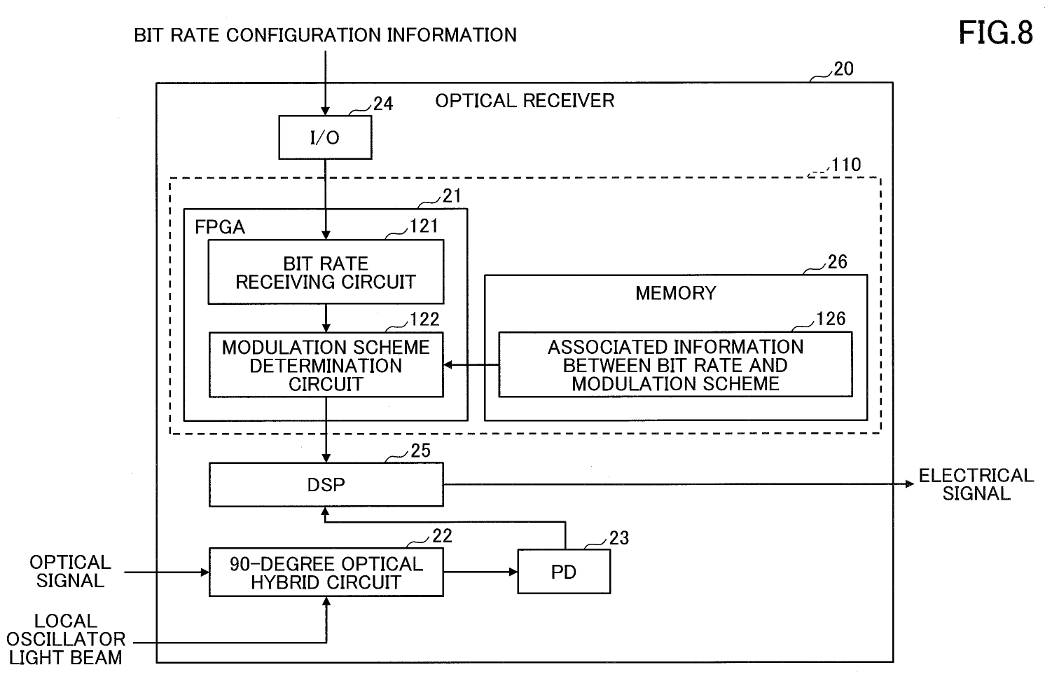

FIG. 8 is a schematic diagram of an optical receiver 20 according to the embodiment. The optical receiver 20 is an example of the optical communication apparatus, and it has an FPGA 21, a 90-degree optical hybrid circuit 22, a set of photodetectors (denoted as “PD” in the drawing) 23, an input/output interface (denoted as “I/O” in the figure) 24, a DSP 25, and a memory 26.

The FPGA 21 includes a bit rate receiving circuit 121 and a modulation scheme determination circuit 122. The bit rate receiving circuit 121 receives bit rate configuration information via the I/O interface 24. The modulation scheme determination circuit 122 searches in the associated information 126 saved in the memory 26, of which the information describes the relationship between bit rate and modulation scheme, to determine a modulation scheme in accordance with the bit rate. The selected modulation scheme is supplied to the DSP 25.

As in the optical transmitter 10, the FPGA 21 and the memory 26 may form a functional block of the modulation scheme selector part 110. When the PPGA 21 has a built-in memory, the modulation scheme selector part 110 may be formed by the FPGA 21 solely.

The 90-degree optical hybrid circuit 22 detects a received light signal using a local oscillation light beam and outputs components of XI, XQ, YI, and YQ. Each of the XI, XQ, YI, and YQ components are detected as a photocurrent by the associated photodetector 23, and converted into an analog voltage by a transimpedance amplifier or the like. The analog signal is then digitally sampled, and input to the DSP 25.

The DSP 25 performs digital signal processing including compensation for chromatic dispersion and waveform distortion on the input digital signal. The DSP 25 then allocates the digitally compensated data onto the corresponding constellation points according to the selected modulation scheme, and demaps the constellation points to a bit sequence. When DP-aQAM has been selected, it is simply determined to which area on the constellation plane the coordinate point of the detected signal belongs, and the amount of calculation is small. When 4D-mAnPSK has been selected, a constellation point the closest from the coordinate point of the detected signal is determined in the three-dimensional space. Although, in this case, the amount of computation increases, the data transfer quality including tolerance to fiber optic nonlinearity is maintained at high quality. The acquired bit sequence is then subjected to error correction and decoding, and output as an electrical signal.

In the optical receiver 20, a modulation scheme is selected according to the currently configured bit rate. For the adaptive modulation, increase in power consumption can be suppressed, while maintaining the data transfer quality satisfactorily.

### <3. Configuration Example of Optical Transceiver>

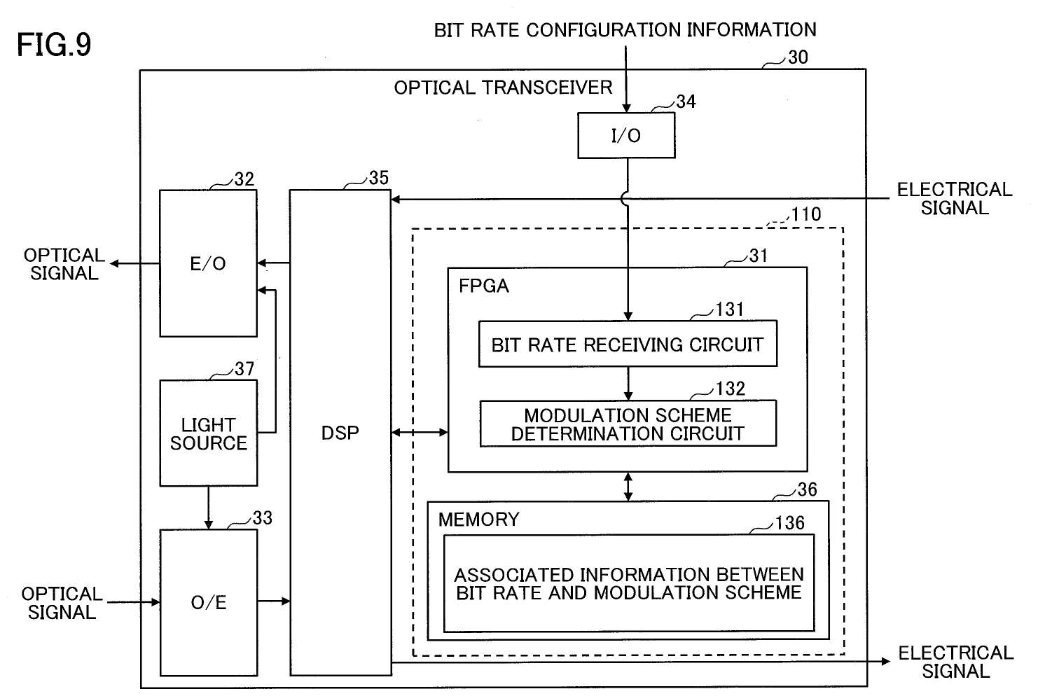

FIG. 9 is a schematic diagram of an optical transceiver 30. Since in general optical communications are implemented bidirectionally, the configuration for adaptively selecting a modulation scheme in response to the channel spacing and the bit is applicable to the optical transceiver 30 with the optical transmitter 10 of FIG. 5 and the optical receiver 20 of FIG. 8 integrated therein.

The optical transceiver 30 is an example of the optical communication apparatus, and it has an FPGA 31, an electrical to optical conversion circuit (denoted as “E/O” in the figure) 32, and an optical to electrical conversion circuit (denoted as “O/E” in the figure) 33, an input and output interface (denoted as “I/O” in the figure) 34, a DSP 35, a memory 36, and a light source 37.

The FPGA 31, the DSP 35, and the memory 36 may be shared between the transmission block and the reception block. The FPGA 31 has a bit rate receiving circuit 131 and a modulation scheme determination circuit 132. The bit rate receiving circuit 131 receives bit rate configuration information via the I/O 34. The modulation scheme determination circuit 132 searches for the associated field of the associated information 136 stored in the memory 36, and it determines a modulation scheme in accordance with the bit rate. The determined modulation scheme is supplied to the DSP 35.

The FPGA 31 and the memory 36 may form a functional block of the modulation scheme selector part 110. When the FPGA 31 has a built-in memory, the associated information 136 may be saved in the built-in memory of the FPGA 31. In the latter case, the modulation scheme selector part 110 may be implemented solely by the FPGA 31.

For the transmission block, the DSP 35 maps a data signal to be transmitted to the constellation points on the I-Q plane according to the configured modulation scheme, and generates digital signals according to the logical values of the data signal. At the E/O 32, the digital signals are converted into high-frequency analog drive signals and input to an optical modulator.

A light beam emitted from the light source 37 is incident on the optical modulator of the E/O 32, modulated by the analog drive signals, and then output as optical signals.

For the reception block, the DSP 35 performs digital signal processing such as compensation for chromatic dispersion and waveform distortion on the signal detected by the O/E 33 and digitally sampled. The received signal having been subjected to the digital compensation is distributed onto the constellation plane, and constellation points are determined according to the modulation scheme selected by the modulation scheme determination circuit 132. Then, data bits are recovered and output as electrical signals after error correction and decoding.

In the optical transceiver 30, a modulation scheme is selected adaptively according to the bit rate. For the adaptive modulation, increase in power consumption can be suppressed, while maintaining the data transfer quality satisfactorily.

### <4. Operation Flow of Modulation Scheme Selection>

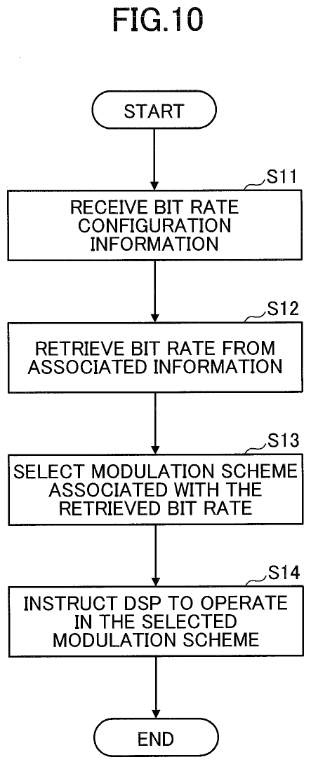

FIG. 10 is a flowchart performed by the modulation scheme selector part 110. This operation flow is carried out when, for example, the optical transceiver 30 is newly added to the network, or the optical transceiver 30 is rebooted. Alternatively, the operation flow may be carried out when an optical transponder having the optical transceiver 30 is newly introduced in the network or rebooted, as will be described later.

The operation flow of FIG. 10 is based upon a configuration in which the associated information saving part 146 of the modulation scheme determination part 142 has a table format as illustrated in FIG. 6. First, bit rate configuration information is received at the bit rate input part 141 (S11). The bit rate configuration information may be received from the network as a part of an optical network supervisory signal, or it may be input by an operator who installs the optical transceiver 30 in the network. Then, the modulation scheme searching part 143 searches in the associated information saving part 146 (S12) and specifies the modulation scheme associated with the bit rate (S13).

For example, when the bit rate is 400 Gbps, the table 113 is retrieved and the modulation scheme of DP-16QAM associated with 400 Gbps is selected. When the bit rate is 200 Gbps, the table 113 is retrieved and the modulation scheme of 4D-2A8PSK associated with 200 Gbps is selected.

The modulation scheme instructing part 145 instructs the DSP 35 to operate at the determined modulation scheme (S15). The DSP 35 maps the inputted data signal onto the constellation plane according to the modulation scheme to generate electrical modulation signals for data transmission. Also, the received optical signal is converted into electrical signals, and the electrical signals are distributed onto the constellation plane to estimate the constellation points for data recovery.

With this method, a modulation scheme is selected adaptively at the optical communication apparatus according to the bit rate. Increase of power consumption is suppressed for the adaptive modulation, while maintaining the data transfer quality satisfactory.

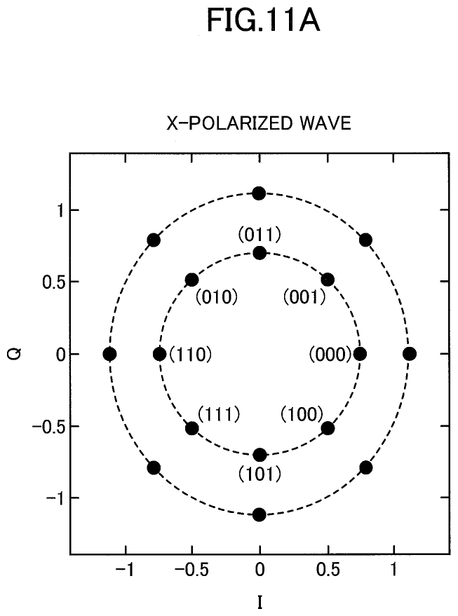

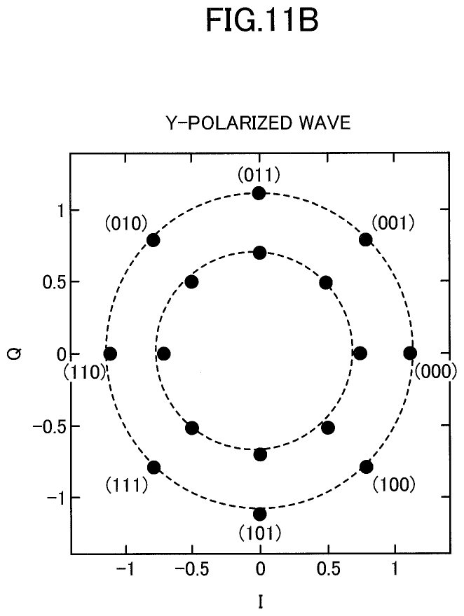

FIG. 11A and FIG. 11B are constellation diagrams of 4D-2A8PSK. FIG. 11A illustrates constellation points for X polarization, and FIG. 11B illustrates constellation points for Y polarization. In this example, eight signal constellation points (3 bits) are distributed along the inner circle for X polarization, eight signal constellation points (3 bits) are distributed along the outer circle for Y polarization, and the total of 6-bits per symbol modulation is performed.

In this modulation scheme, constellations of the X and Y polarizations are controlled such that the radius of the constellation points of the Y polarization becomes r2 when the radius (i.e., the amplitude) of the constellation points of the X-polarization is r1, and such that the amplitude of the constellation points of the Y polarization becomes r1 when the amplitude of the constellation points of the X polarization is r2. Under this control, the power can be maintained constant during one modulation (i.e., for one symbol).

When the number of circles is three, the value “m” of 4D-mAnPSK becomes 3 and signal constellation points are distributed at three levels of amplitude. In this case, when a first circle is allocated to one polarization at the first radius (amplitude), then the second and third radii other that the first radius are allocated to the other polarization, and constellation points are controlled such that the power is maintained constant for one symbol.

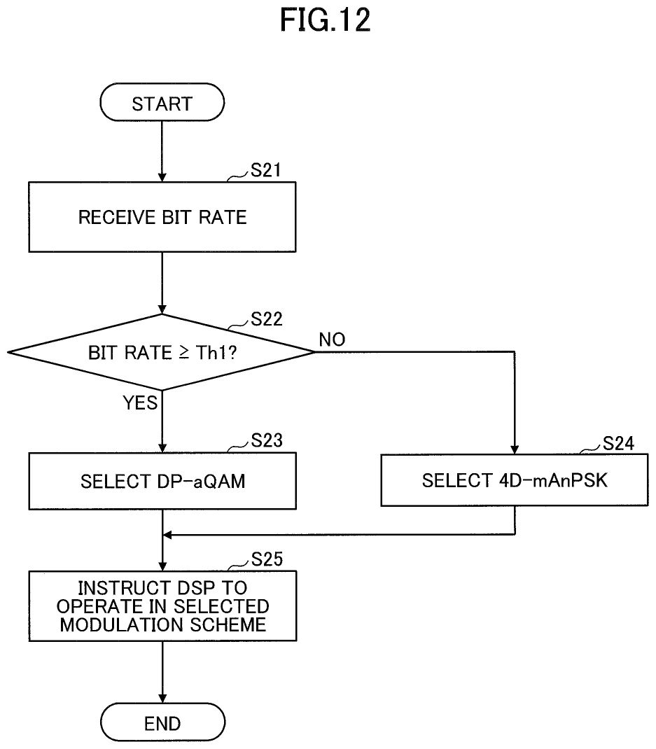

FIG. 12 is a flowchart of a first modification of a modulation scheme selection process performed by the modulation scheme selector part 110. The operation flow of FIG. 12 is based upon a configuration in which the associated information is defined by a function in the associated information saving part 146 of the modulation scheme determination part 142 (see FIG. 7).

First, bit rate configuration information is received at the bit rate input part 141 (S21). Then, the modulation scheme searching part 143 refers to the associated information 146 and determines whether the received bit rate is equal to or greater than the first threshold Th1 (S22). When the bit rate is equal to or greater than the first threshold Th1 (Yes in S22), DP-aQAM is selected (S23). When the bit rate is less than the first threshold Th1 (No in S22), 4D-mAnPSK is selected (S24). An instruction is supplied to the DSP to operate at the modulation scheme selected in step S23 or S24 (S25).

For instance, when the designated bit rate is equal to or greater than 400 Gbps, a DP-aQAM equal to or higher than DP-16QAM is selected. When the specified bit rate is less than the 400 Gbps, a 4D-mAnPSK scheme, such as 7b4D-2A8PSK, 4D-2ABPSK, etc. is selected. In place of the above-described function, another function that describes the relationship between the bit rate and the number of bits per symbol (or the amount of information of a symbol) may be used.

With this method of modulation scheme selection, optical communication apparatus can select adaptively a modulation scheme according to the bit rate, and increase of power consumption is suppressed for the adaptive modulation, while maintaining the data transfer quality satisfactory.

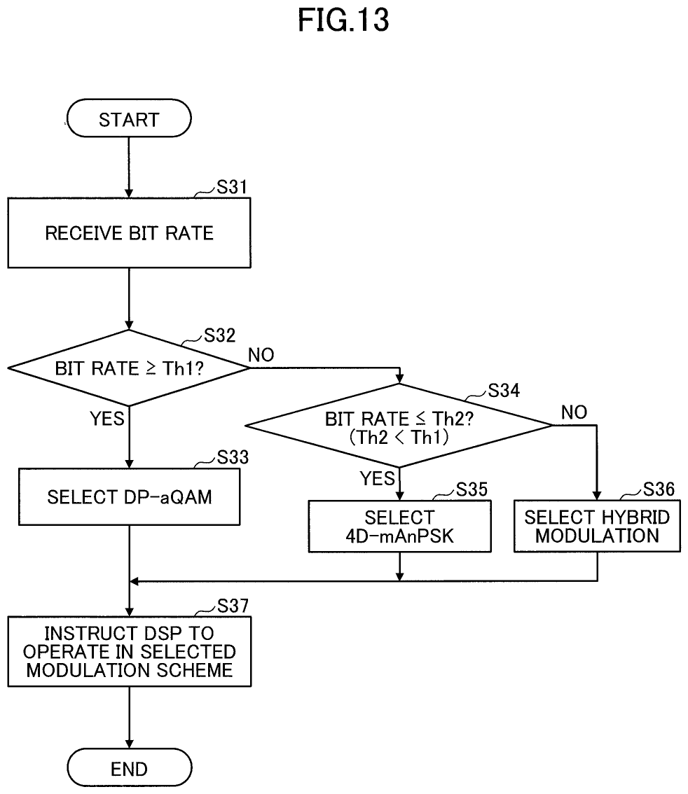

FIG. 13 is a flowchart of a second modification of a modulation scheme selection process performed by the modulation scheme selector part 110. The operation flow of FIG. 13 may be performed when the associated information saving part 146 of the modulation scheme determination part 142 is described by a function using two or more threshold values.

First, bit rate configuration information is received at the bit rate input part 141 (S31). The modulation scheme searching part 143 refers to the associated information 146 and determines whether the received bit rate is whether the received bit rate is equal to or greater than the first threshold Th1 (S32). When the bit rate is equal to or greater than the first threshold Th1 (Yes in S32), DP-aQAM is selected (S33).

When the bit rate is less than the first threshold Th1 (No in S32), it is further determined whether the received bit rate is equal to or less than the second threshold Th2 that is smaller than the first threshold Th1 (S34). When the bit rate is equal to or less than the second threshold Th2 (Yes in S23), 4D-mAnPSK scheme is selected (S35).

When the bit rate is between the second threshold Th2 and the first threshold Th1 (No in S34), a hybrid modulation scheme combining DP-aQAM and 4D-mAnPSK is selected (S36). An instruction is supplied to the DSP to have the DSP operate at the modulation scheme selected in S33, S35, or S36 (S37).

For instance, when the designated bit rate is equal to or greater than 400 Gbps, a DP-aQAM equal to or higher than DP-16QAM is selected. When the bit rate is equal to or less than the 200-Gbps, a 4D-mAnPSK scheme such as 4D-2A8PSK is selected depending on the bit rate value.

When the bit rate is between 200 Gbps and 400 Gbps, hybrid modulation combining DP-16QAM and 4D-2A8PSK may be selected.

With this method of modulation scheme selection, an optical communication apparatus can select a modulation scheme adaptively in accordance with the bit rate. Power consumption for adaptive modulation is suppressed from increasing, while maintaining the satisfactory data transfer quality.

### <5. Optical Transport System>

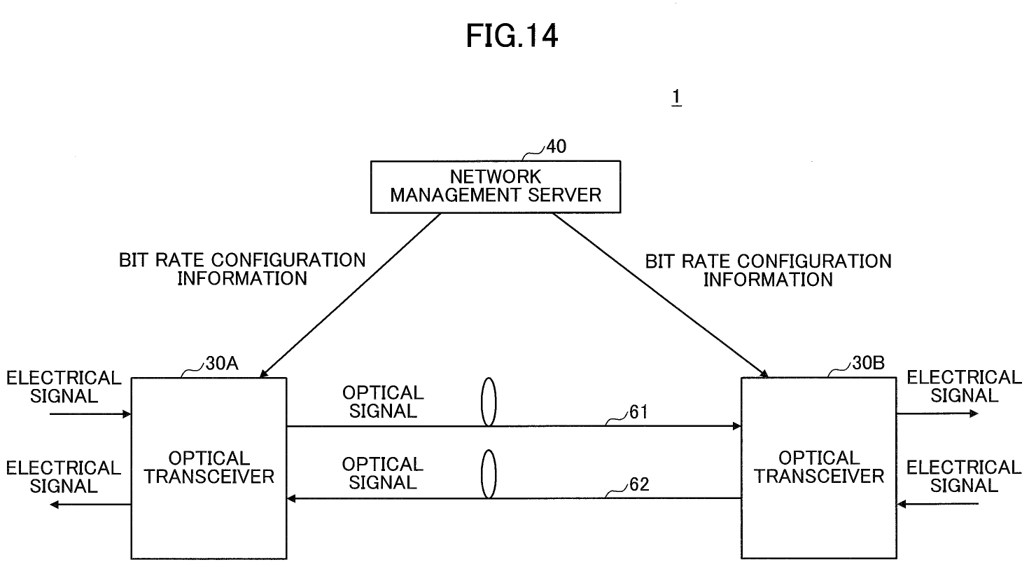

FIG. 14 is a schematic diagram of an optical transport system 1 according to an embodiment. The optical transport system 1 is a part of an optical network, and it includes an optical transceiver 30A, an optical transceiver 30B, and a network management server 40. The optical transceiver 30A and the optical transceiver 30B are mutually connected by optical transmission paths 61 and 62, and each of them is connected to the network management server 40 by the optical network.

The network management server 40 notifies the optical transceivers 30A and 30B of the bit rate configured in the network. The bit rate may be set by a network operator based upon the performances of optical transceivers 30A and 308, the states of the optical transmission paths 61 and 62, a required transmission speed, and so on.

The optical transceivers 30A and 30B select a modulation scheme in accordance with the bit rate, and operate according to the selected modulation scheme. In other words, based upon the selected modulation scheme, electrical signals are converted into optical signals which are output to the optical network, and optical signals received from the optical network are converted into electrical signals from which the data are recovered. The optical transceivers 30A and 30B may be a part of a transponder which is an example of the optical communication apparatus.

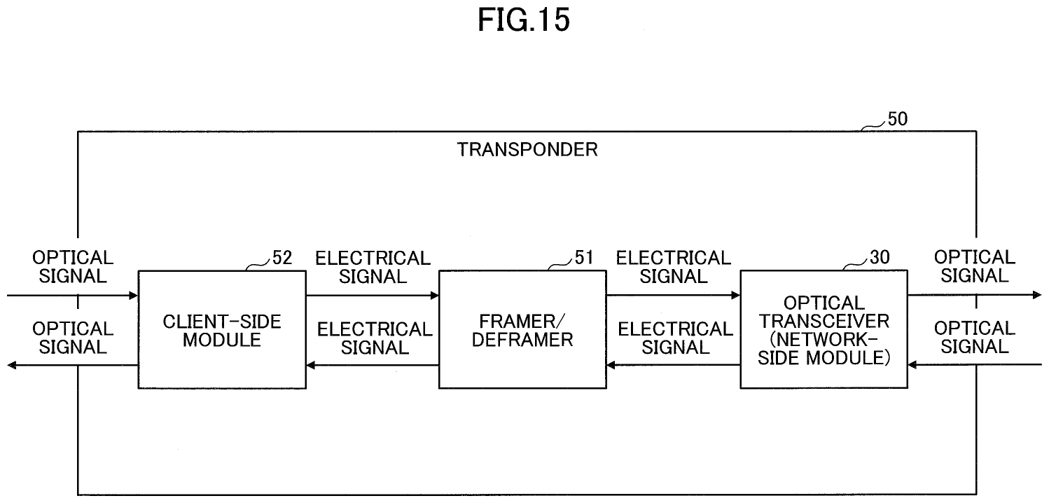

FIG. 15 is a schematic diagram of a transponder 50. The transponder 50 has an optical transceiver 30, a framer/deframer 51, and a client-side module 52. The optical transceiver 30 is one as described above with reference to FIG. 5 to FIG. 9, and operates at a modulation method selected adaptively according to the bit rate set in the network.

The client-side module 52 serves as an interface to a client device, and it converts an optical signal input from a fiber optic Ethernet (registered trademark) cable into an electrical signal and supplies the electrical signal to the framer/deframer 51. In the reverse process, the client-side module 52 receives an electrical signal from the framer/deframer 51, converts the electric signal into an optical signal, and outputs the optical signal toward the client side.

The framer/deframer 51 converts the electric signal of the client-side format into a frame format of the Optical Transport Network (OTN) format and inputs the converted signal to the DSP of the optical transceiver 30. In the reverse process, the OTN electrical signal output from the DSP of the optical transceiver 30 is converted into an electrical signal of the client-side format, and supplied to the client side module 52.

Two or more transponders 50 may be incorporated together with a wavelength multiplexer, a wavelength selective switch, or the like, into a wavelength division multiplexing (WDM) transport equipment. In this case, the optical transceiver 30 of each of the transponders 50 operates at the optimum modulation scheme for the bit rate configured according to the optical transmission path to be connected. Data transfer quality is maintained satisfactorily, while suppressing increase of power consumption.

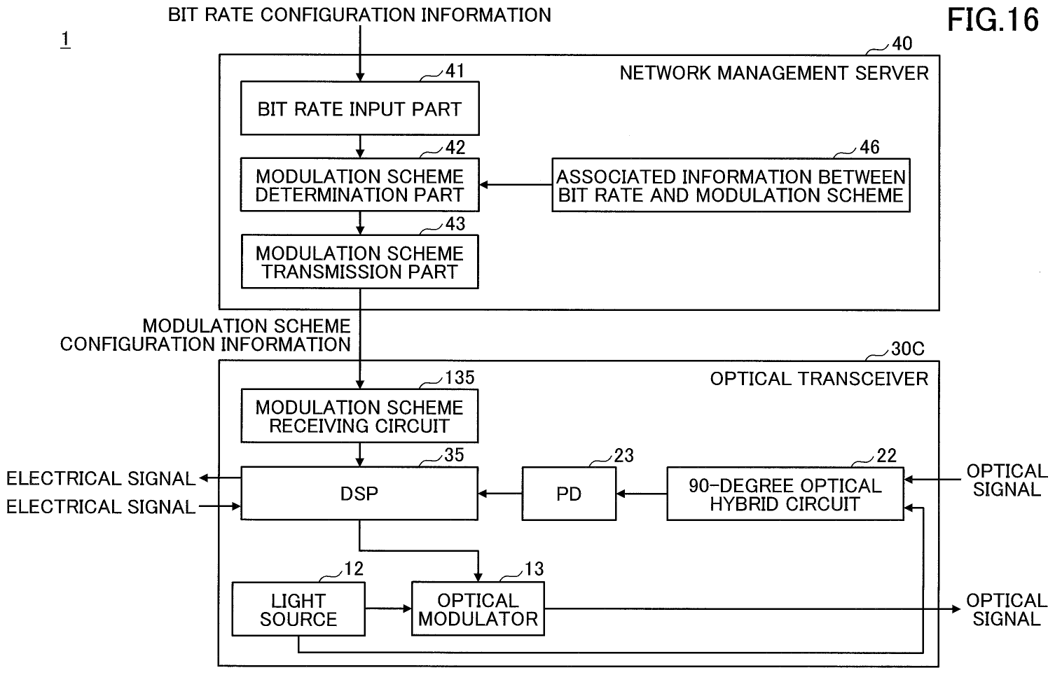

FIG. 16 is a schematic diagram illustrating a network management server 40 and an optical transceiver 30C used in an optical transport system 1 according to an embodiment. In this configuration, the network management server 40 determines a modulation scheme according to the bit rate, and notifies the optical transceiver 30C of the determined modulation scheme.

The network management server 40 is formed of a processor and a memory, and it includes a bit rate input part 41, a modulation scheme determination part 42 and a modulation scheme transmission part 43, and it has associated information 46.

The bit rate input part 41 receives a bit rate inputted by, for example, a network operator. The modulation scheme determination part 42 refers to the associated information 46 to determine a modulation scheme according to the bit rate. The modulation scheme transmission part 43 transmits the determined modulation scheme as modulation scheme configuration information to the optical transceiver 30C.

The bit rate input part 41 may be implemented by an input interface such as a keyboard, a mouse, a touch panel, or the like. The modulation scheme determination part 42 is implemented by a logic device such as an FPGA or a microprocessor. The associated information 46 may be saved in the memory. The modulation scheme transmission part 43 may be implemented by a network interface that provides a connection to the optical transceiver 30C in the network.

The modulation scheme receiving circuit 135 of the optical transceiver 30C receives the modulation scheme configuration information from the network management server 40 and supplies it to the DSP 35. The DSP 35 is configured with the modulation scheme and it operates under this modulation scheme. The data signal to be transmitted is mapped on the constellation plane according to the modulation scheme to generate modulated optical signals. The DSP 35 also distributes the received signal detected by the PD23 onto the constellation plane and determines the signal constellation points according to the modulation scheme.

The operations of the light source 12, the optical modulator 13, the 90 degree optical hybrid circuit 22 and the photo detector (denoted as “PD” in the figure) 23 of the optical transceiver 30C are the same as those explained with reference to FIG. 5 and FIG. 8, and redundant explanation will be omitted.

With this configuration, the optical transceiver 30C simply operates according to the designated modulation scheme, and it can maintain the data transport quality satisfactorily, while suppressing increase of power consumption.

Although the present invention has been described based upon particular embodiments, the present invention is not limited to these examples. The modulation scheme selector part 110 may be implemented by a DSP instead of an FPGA. The correspondence relation between bit rates and modulation schemes is not limited to the example of FIG. 6, and it may be extended so as to include a bit rate of 100 Gbps and/or a bit rate over 600 Gbps.

The modulation scheme adaptively selected by the optical communication apparatus or the server apparatus is not limited to QAM and 4D-mAnPSK schemes. Any type of a first modulation scheme with a sufficient distance between signal constellation points and with the amount of calculation for signal point determination not changing significantly in spite of increase in the degree of multilevel modulation, or any type of a second modulation scheme with a higher transfer performance may be used, depending on the bit rate on the network side.

Either one or both of the network management server 40 and the optical communication apparatus (such as the transponder 50, the optical transceiver 30, or the like) connected to the optical network may determine a modulation scheme adaptively according to the currently configured bit rate. In this case, optical signals are transmitted and received between nodes according to the determined modulation scheme. The bit rate receiving circuit 111 of the optical transmitter 10, the bit rate receiving circuit 121 of the optical receiver 20, and the bit rate receiving circuit 131 of the optical transceiver 30 may be implemented by an I/O interface or any other suitable input interface that can acquire information about transfer conditions including channel spacing and bit rate.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of superiority or inferiority of the invention. Although the embodiments of the present inventions have been described in detail, it should be understood that the various changes, substitutions, and alterations could be made hereto without departing from the spirit and scope of the invention.

What is claimed is:

1. An optical communication apparatus comprising:
an interface circuit that acquires bit rate information of an optical network; and
a processor that selects a modulation scheme in accordance with the bit rate information and operates in the modulation scheme,
wherein the processor is configured to select a first modulation scheme when the bit rate is equal to or greater than a first value, and select a second modulation scheme when the bit rate is smaller than the first value, the second modulation scheme having a data transfer performance higher than the first modulation scheme.

2. The optical communication apparatus as claimed in claim 1, wherein a calculation amount for signal point determination of the second modulation scheme is greater than that of the first modulation scheme.

3. The optical communication apparatus as claimed in claim 1, wherein the processor selects a QAM modulation scheme when the bit rate is equal to or greater than the first value, and selects a 4D-mAnPSK modulation scheme when the bit rate is equal to or less than a second value that is smaller than the first value.

4. The optical communication apparatus as claimed in claim 3, wherein the processor selects a hybrid modulation scheme combining QAM and 4D-mAnPSK when the bit rate is between the second value and the first value.

5. The optical communication apparatus as claimed in claim 1, further comprising:
a memory that saves associated information representing a correspondence relation between the bit rate and the modulation scheme,
wherein the processor selects the modulation scheme referring to the associated information.

6. The optical communication apparatus as claimed in claim 5, wherein the associated information is in a table format in which the modulation scheme is associated with each of available bit rates.

7. The optical communication apparatus as claimed in claim 5, wherein the associated information is a function that describes a relation between the bit rate and the modulation scheme.

8. The optical communication apparatus as claimed in claim 1, wherein the interface circuit receives the bit rate information from the optical network to which the optical communication apparatus is connected.

9. A server apparatus used in an optical network to which an optical communication apparatus is connected, comprising:
an input circuit that receives bit rate configuration information of the optical network,
a processor that selects a modulation scheme in accordance with a bit rate indicated by the bit rate configuration information, and
a transmitter that transmits the modulation scheme selected by the processor to the optical communication apparatus,
wherein the processor is configured to select a first modulation scheme when the bit rate is equal to or greater than a first value, and select a second modulation scheme when the bit rate is smaller than the first value, the second modulation scheme having a data transfer performance higher than the first modulation scheme.

10. The server apparatus as claimed in claim 9, wherein a calculation amount for signal point determination of the second modulation scheme is greater than that of the first modulation scheme.

11. The server apparatus as claimed in claim 9, further comprising:
a memory that saves associated information describing a correspondence relation between the bit rate and the modulation scheme,
wherein the processor selects the modulation scheme by referring to the associated information.

12. An optical transport system comprising:
an optical communication apparatus connected to an optical network; and
a server apparatus that manages the optical network,
wherein at least one of the optical communication apparatus and the server apparatus determines a modulation scheme in accordance with a bit rate provided for the optical communication apparatus, and
wherein the modulation scheme is determined such that a first modulation scheme is selected when the bit rate is equal to or greater than a first value, and that a second modulation scheme is selected when the bit rate is smaller than the first value, the second modulation scheme having a data transfer performance higher than the first modulation scheme.

13. The optical transfer system as claimed in claim 12, wherein a calculation amount for signal point determination of the second modulation scheme is greater than the first modulation scheme.

14. The optical transport system as claimed in claim 12, wherein the modulation scheme is determined at the server apparatus, and the server apparatus notifies the optical communication apparatus of the modulation scheme.

15. The optical transport system as claimed in claim 13, wherein the server apparatus notifies the optical communication apparatus of the bit rate, and the optical communication apparatus determines the modulation scheme based upon the bit rate.

16. An optical communication method implemented by an optical communication apparatus used in an optical transport system, comprising:
acquiring a bit rate;
selecting a modulation scheme according to the bit rate; and
transmitting and receiving an optical signal in the modulation scheme selected,
wherein selecting the modulation scheme includes selecting a first modulation scheme when the bit rate is equal to or greater than a first value, and selecting a second modulation scheme when the bit rate is smaller than the first value, the second modulation scheme having a data transfer performance higher than the first modulation scheme.

17. The optical communication method as claimed in claim 16, wherein a calculation amount for signal point determination of the second modulation scheme is greater than that of the first modulation scheme.

18. The optical communication method as claimed in claim 16, wherein a QAM modulation scheme is selected as the first modulation scheme when the bit rate is equal to or greater than the first value, and a 4D-mAnPSK modulation scheme is selected as the second modulation scheme when the bit rate is equal to or less than a second value that is smaller than the first value.

19. The optical communication method as claimed in claim 18, wherein a hybrid modulation scheme combining QAM and 4D-mAnPSK is selected when the bit rate is between the second value and the first value.

20. The optical communication method as claimed in claim 16, wherein the bit rate is received from a server apparatus that manages the optical transport system.
